(19) United States
(12) Patent Application Publication
(10) Pub. No.: US 2007/0249421 A1
(43) Pub. Date: Oct. 25, 2007

(54) Privacy video assembly for electronic game playing

(76) Inventor: Donald White, Sarnia (CA)

Correspondence Address: JAMES RAY & ASSOCIATES, 2640 PITCAIRN ROAD, MONROEVILLE, PA, 15146, US

(21) Appl. No.: 11/789,748

(22) Filed: Apr. 25, 2007

Related U.S. Application Data
(60) Provisional application No. 60/794,665, filed on Apr. 25, 2006.

(51) Int. Cl. A63F 13/00

(52) U.S. Cl. 463/40

(57) ABSTRACT

An apparatus for multi-player video games comprising two or more horizontal planar surfaces, and at least two substantially vertical side members supporting the upper horizontal planar surface at least six inches above one lower horizontal panel with a video cable manifold positioned between the two uppermost horizontal planar surfaces with at least one video input connection compatible with at least one common commercial video game. The manifold also includes at least two video output connections compatible with a variety of video devices including televisions, high-definition TV monitors, and computer monitors. At least two preselected moving aids are included under said lower substantially horizontal planar surface.

### CROSS REFERENCE TO RELATED APPLICATION

This patent application is related to and claims priority from U.S. Provisional Patent Application Ser. No. 60/794,665 filed Apr. 25, 2006.

### FIELD OF THE INVENTION

The present invention relates, in general, to apparatus for holding video screens for electronic game playing and, more particularly, this invention relates to apparatus for connecting and holding multiple video devices at substantially different viewing angles during multi-player video games

### BACKGROUND OF THE INVENTION

Prior to the conception and development of the present invention, video games have been most commonly played using a single television or video monitor. Typically, these TV's or monitors have been the cathode-ray tube (CRT) type that has a cabinet extending 15 inches or more in depth. There are a number of known video games in which multiple players compete against each other in real time. When more than two players are involved, there can be crowding around the screen. Furthermore, some multi-player video games would best be played such that competing players could not see what their opponents are seeing and doing on the screen at certain times. Only a few proposals have been put forth to deal with this situation until now.

Coffey in U.S. Pat. No. 5,435,557 disclosed an add-on television screen divider that could shield one half of screen from viewing by someone standing in front of the other half. Drawbacks to this design are the two-player limit, the need to stand close to the television, and the necessity for the game electronics to be able to divide the screen into two equal parts.

In U.S. Pat. No. 5,618,045, Kagan et al describe a multi-player game system in which participants each have a hand-held controller and video display with wireless communication between them or a common play station. With this system, the screens are relatively small and interfacing with various and newer game units is likely to be a problem.

In U.S. Pat. No. 6,079,709, Etheridge teaches a rather complex housing containing mirrors and dividers that could allow four individuals to secretly view just one quarter of a video screen divided electronically into four separate segments.

In U.S. Patent Application No. 2004/0259635, Germeraad presents the need for private game player's screens and a concept for satisfying that need, but there are few if any concrete details on how this might be done.

While it would be physically possible to arrange three or four CRT video devices at right angles to one another for private viewing, this would be impractical to do routinely given the size and weight of such devices. Since about 2004, the thin panel type of televisions and monitors, such as LCD and plasma, have encountered steep drops in pricing, and there has been a proliferation of sizes, makes, and models available. This creates opportunities for solving the multi-player game problem, but there is still a need for an economical and convenient solution.

### SUMMARY OF THE INVENTION

The present invention provides a relatively inexpensive and convenient way to assemble and connect privately viewable video devices to multi-player electronic games. An apparatus for multi-player video games comprising two or more horizontal planar surfaces, and at least two substantially vertical side members supporting the upper horizontal planar surface at least six inches above one lower horizontal planar with a video cable manifold positioned between the horizontal planar surfaces having at least one video input connection compatible with at least one common commercial video game. The manifold also includes at least two video output connections compatible with a variety of video devices including televisions, high-definition TV monitors, and computer monitors. At least two moving aids are included under said lower substantially horizontal planar surface.

In an alternative embodiment, multiple video screens, a video-game compatible manifold, and power strip are built into one housing that can be placed upon suitably sized tables and stands.

### OBJECTS OF THE INVENTION

It is, therefore, one of the primary objects of the present invention to provide an inexpensive and convenient apparatus for assembling and connecting multiple and various types of video displays to one or more video game units such that only one display is viewable by each player.

Another object of the present invention is to provide an economical space-saving television stand that can be converted into an apparatus for video game playing with privately viewable video monitors for each player.

Still another object of the present invention is to provide a multi-screen video game-playing video assembly.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of a space-saving version of the multi-player video game apparatus.

FIG. 2 is a side view of the space-saving version of the video game apparatus.

FIG. 3 is a perspective view of the video game apparatus with an enclosed bottom cabinet.

FIG. 4 is a perspective view of an alternative embodiment housing three video screens in a single housing.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures. In all cases, a video game box is shown, but it is not an integral part of the invention.

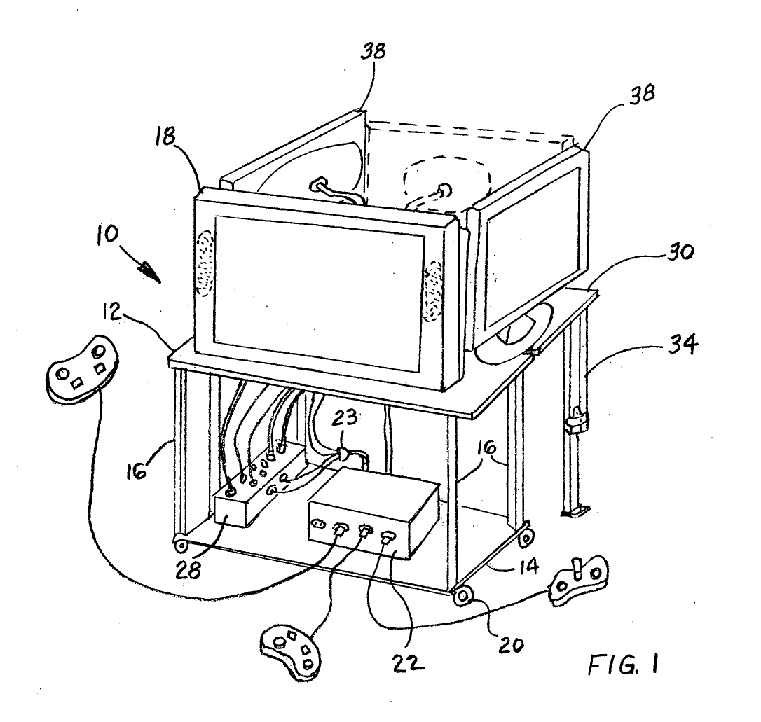

Referring first to FIG. 1, there is presented a perspective view of the assembly and apparatus 10 in a space-saving version. A base panel 14 riding on casters 20 supports the permanently horizontal top panel 12 by way of support pillars 16. An LCD or similar thin-panel television or TV monitor 18 with built-in speakers sits on the top panel 12. When the expansion leaf 30 is rotated to the horizontal position and held there by two or more legs 34, up to three additional video displays 38 can be positioned at about 90 degrees to one another. The TV 18 can typically be connected to cable or satellite signals, or video players for DVD's and VCR's. For video game playing where privacy is desirable, the top platform, 12 plus 30, can accommodate up to three additional video displays. For connection to one game system 22 of immediate interest, the video output via component cable 23 is routed to the appropriate input connection on manifold 28 having multiple outputs of various types, such as, coaxial cable, S-video, HDMI, and multi-pin connectors. The manifold 28 can have multiple types of video and audio inputs corresponding to the most popular game systems. An opening in the top horizontal panel allows easy passage of cables and wires. The audio cables would most commonly go directly to the television or monitor 18 with speakers, but passage through the manifold 28 is an option.

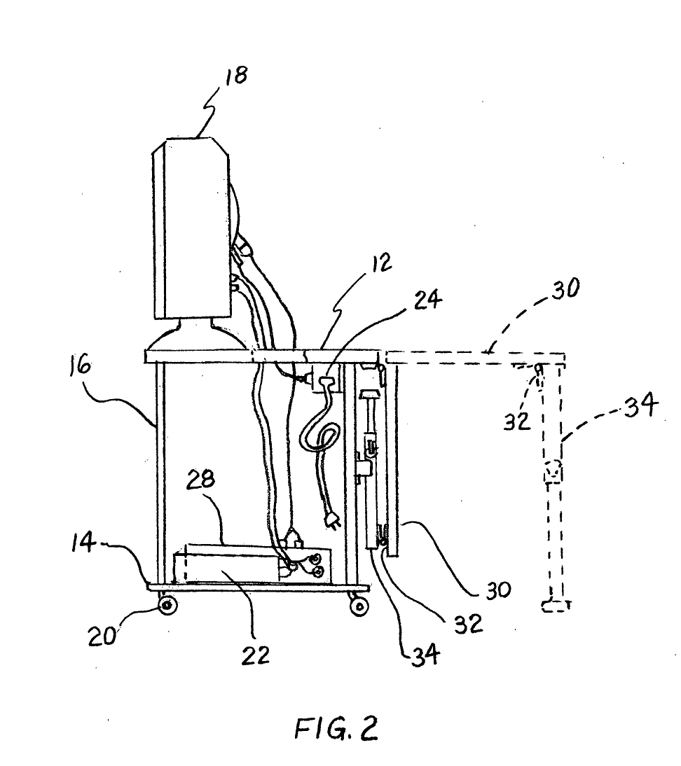

FIG. 2 provides a side view of the space-saving design in the compact configuration with the leaf 30 folded down and one leg 34 folded up with the operation of hinges 32. Only the television 18 is shown resting on top 12. Cables and cords pass through opening 21. Power strip 24 is attached to the underside of top 12 to facilitate plugging in several TV's or monitors.

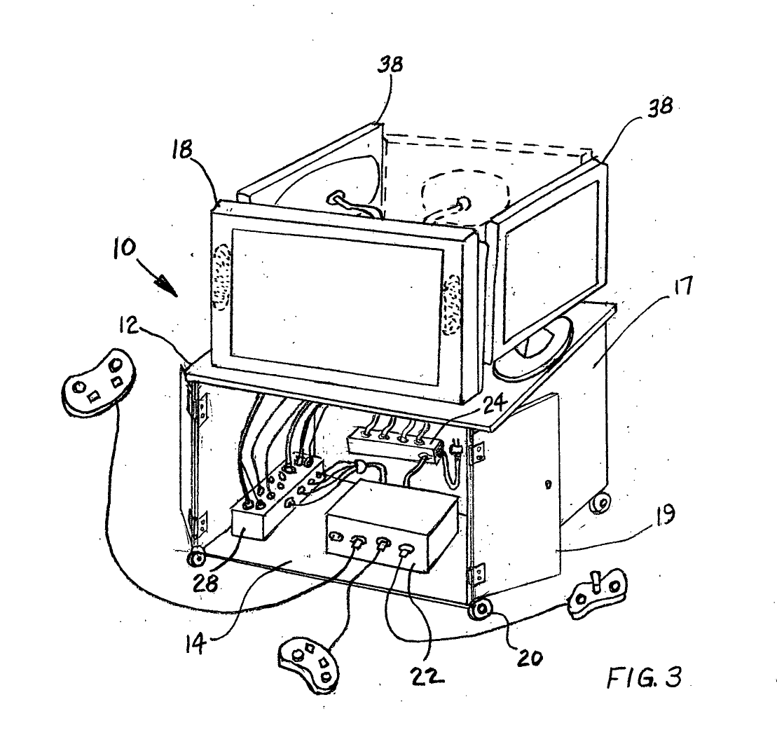

FIG. 3 depicts a variation of the FIG. 1 design wherein the support pillars are replaced with solid side panels 17, and doors 19 are added to allow for a much neater appearance when the game is not being played. The power strip/surge suppressor 24 is shown in an alternative location resting on the bottom panel 14

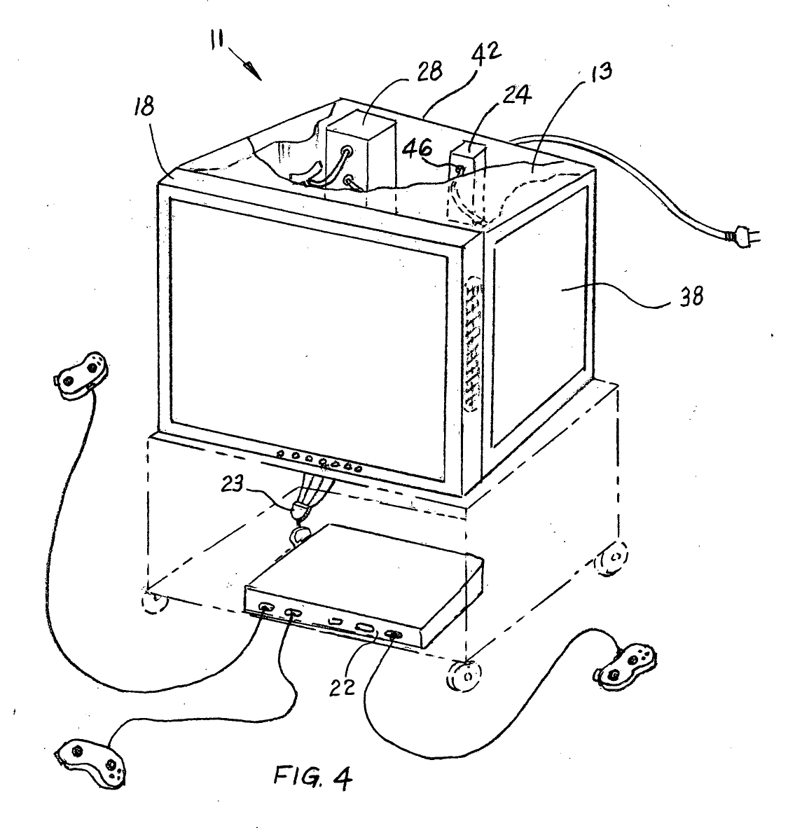

FIG. 4 depicts an alternative embodiment of the invention which discloses a three-screen video display 11 built around a thin-panel television or HDTV monitor 18 as the front surface and viewing panel as well as sound unit. Two other video monitors 38, such as LCD units are visible through side window-like panels. The video connection manifold 28 and the power strip 24 are built into the back panel 42 such that input connections are on the exterior, and the outputs 44 are on the inside. Vented top 13 completes the enclosure.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

I claim:

1. An apparatus for multi-player video games comprising:
a) at least one lower substantially horizontal planar surfaces;
b) an upper substantially horizontal planar surface;
c) at least two substantially vertical side members supporting said upper horizontal planar surface at least six inches above nearest said lower horizontal planar surface;
d) a video port manifold positioned between said substantially horizontal planar surfaces with at least one video input connection compatible with at least one common commercial video game, and said video port manifold also including at least two video output connections; and
e) at least two preselected moving aids under said lower substantially horizontal planar surface.

2. The apparatus, according to claim 1, wherein said at least two video output connections are compatible with at least one of televisions, high-definition TV monitors, computer monitors, and video projectors.

3. The apparatus, according to claim 1, wherein said upper horizontal planar surface is in two sections connected with hinges and with at least one hinged support leg distal to said hinges connecting said two sections.

4. The apparatus, according to claim 1, wherein said moving aids are casters.

5. The apparatus, according to claim 1, wherein said moving aids are sliding surfaces riding on a low-friction polymer material.

6. The apparatus, according to claim 1, wherein said substantially vertical side members are one of solid panels and columns.

7. The apparatus, according to claim 1, wherein said upper horizontal planar surface contains one of an aperture and slots for passing through one of cords and cables.

8. The apparatus, according to claim 1, wherein a combination power strip/surge protector is positioned between said horizontal planar surfaces

9. A substantially cubical multi-screen video cabinet comprising:
a) a substantially horizontal floor panel;
b) a front thin-panel video screen consisting of one of a television, high-definition TV monitor, and computer monitor;
c) two substantially vertical window-like side panels, each connected at one end to one substantially vertical edge of said front thin-panel video screen;
d) a rear panel with at least one air vent, said rear panel connected to substantially vertical edges of said two window-like side panels;
e) a removable top panel with at least one ventilation aperture; said top panel peripherally attached to horizontal top edges of said front thin panel video screen, said two window-like side panels, and said rear panel;
f) two thin-panel video monitors placed inside said multi-screen video cabinet to be viewable through said window-like side panels;
g) an audio-video connection manifold attached to said rear panel such that at least one video input connection is accessible at exterior of said rear panel, and at least two video output connections are available inside said multi-screen video cabinet; and
h) a combination power strip/surge suppressor attached to said rear panel to allow at least two electric power outlets are available inside said multi-screen video cabinet.

10. The apparatus, according to claim 9, wherein said at least two video output connections are compatible with at least one of televisions, high-definition TV monitors, computer monitors.

11. The apparatus, according to claim 9, wherein said at least one video input connection is compatible with at least one common commercial video game system.
